(19) United States
(12) Patent Application Publication
(10) Pub. No.: US 2026/0178645 A1
(43) Pub. Date: Jun. 25, 2026

(54) AI-BASED SENTIMENT DETERMINATION FOR CONTRACT JOB-RELATED USER FEEDBACK

(71) Applicant: CoreLogic Solutions, LLC, Irvine, CA (US)

(72) Inventors: Caitlin Rios, San Diego, CA (US); Uyen Hoang, Costa Mesa, CA (US)

(21) Appl. No.: 19/426,986

(22) Filed: Dec. 19, 2025

Related U.S. Application Data
(60) Provisional application No. 63/738,303, filed on Dec. 23, 2024.

(51) Int. Cl. G06F 16/34; G06F 40/20; G06Q 30/0282

(52) U.S. Cl. CPC G06F 16/345; G06F 40/20; G06Q 30/0282

(57) ABSTRACT

Systems and methods for a feedback analysis system to identify a sentiment associated with user feedback (e.g., notes) and generates a task based on the identified sentiment. Specifically, the feedback analysis system as described herein may receive user feedback corresponding to a contract job and provide the user feedback as input into a large language model to identify a sentiment associated with the user feedback. In response to the user feedback as input, the feedback analysis system may synthesize, based on the identified sentiment of the user feedback, a summarized sentiment, wherein the summarized sentiment indicates a level of satisfaction associated with a performance of the contract job. In some embodiments, the feedback analysis system generates a task based on the user feedback and the summarized sentiment, wherein the task is one of a notification, an alert, an update, or an automated process related to the contract job.

### CROSS-REFERENCE TO RELATED APPLICATIONS

This present application claims priority from U.S. Provisional No. 63/738,303, filed on Dec. 23, 2024, entitled “AI-BASED SENTIMENT DETERMINATION FOR CONTRACT JOB-RELATED USER FEEDBACK,” which is hereby incorporated by reference herein in its entirety. Any and all applications for which a foreign or domestic priority claim is identified in the Application Data Sheet as filed with the present application are hereby incorporated by reference under 37 CFR 1.57 for all purposes and for all that they contain.

### BACKGROUND

Restoration contract jobs typically involve repairs or renovations to properties undertaken by contractors. To provide feedback about the job, property owners may send notes through an insurance agent or company, a third-party system, or the like. However, direct contact between owners and contractors may be limited. As such, contractors may not be aware of an owner's sentiment regarding a past or ongoing job, which may be important in gaining insight or feedback for ongoing projects.

### SUMMARY

The systems, methods, and devices described herein each have several aspects, no single one of which is solely responsible for its desirable attributes. Without limiting the scope of this disclosure, several non-limiting features will now be discussed briefly.

In some aspects, the techniques described herein relate to a system, comprising: a computer-readable storage medium storing program instructions; and one or more processors configured to execute the program instructions to cause the system to: receive user feedback corresponding to a contract job, wherein the user feedback includes a text-based comment; provide the user feedback as input into a large language model, wherein the large language model outputs a sentiment associated with the user feedback in response to the user feedback being provided as the input to the large language model; and synthesize, based on the sentiment of the user feedback, a summarized sentiment, wherein the summarized sentiment indicates a level of satisfaction, such as an overall level of satisfaction, associated with a performance of the contract job; and generate a task based on the user feedback and the summarized sentiment.

In some aspects, the techniques described herein relate to a system, wherein the task is one of a notification, an alert, an update, or an automated process related to the contract job.

In some aspects, the techniques described herein relate to a system, wherein the summarized sentiment is synthesized in response to the user feedback being provided as the input to the large language model.

In some aspects, the techniques described herein relate to a system, wherein the sentiment is one of very positive, positive, neutral, negative, or angry.

In some aspects, the techniques described herein relate to a system, wherein the user feedback includes a plurality of text-based comments relating to the contract job.

In some aspects, the techniques described herein relate to a system, wherein the summarized sentiment includes an average sentiment based on the plurality of text-based comments indicating a trend or average performance of the contract job over a duration.

In some aspects, the techniques described herein relate to a system, comprising: a computer-readable storage medium storing program instructions; and one or more processors configured to execute the program instructions to cause the system to: receive user feedback corresponding to a contract job, wherein the user feedback includes a text-based comment; filter the text-based comment to remove a subset of content from the text-based comment; provide the user feedback as input into a large language model to output a sentiment associated with the user feedback and a sentiment score, wherein the sentiment indicates a level of satisfaction with the contract job; synthesize, based on the sentiment of the user feedback and additional sentiments associated with the contract job, a summarized sentiment, wherein the summarized sentiment indicates an overall level of satisfaction associated with a performance of the contract job; and generate a task based on the user feedback and the summarized sentiment.

In some aspects, the techniques described herein relate to a system, wherein the task is one of a notification, a message, an alert, an update, an inquiry, or an automated process related to the contract job.

In some aspects, the techniques described herein relate to a system, wherein the summarized sentiment is synthesized in response to the user feedback being provided as the input to the large language model.

In some aspects, the techniques described herein relate to a system, wherein the sentiment is one of very positive, positive, neutral, negative, or angry.

In some aspects, the techniques described herein relate to a system, wherein the user feedback includes a plurality of text-based comments relating to the contract job.

In some aspects, the techniques described herein relate to a system, wherein the summarized sentiment indicates a trend or average performance of the contract job over a duration.

In some aspects, the techniques described herein relate to a system, wherein the subset of content includes personal information, a job status, content related to a contractor, or a plan for future action.

In some aspects, the techniques described herein relate to a method, comprising: receiving user feedback corresponding to a contract job, wherein the user feedback includes a text-based comment; filtering the text-based comment to remove a subset of content from the text-based comment; providing the user feedback as input into a large language model to output a sentiment associated with the user feedback and a sentiment score, wherein the sentiment indicates a level of satisfaction with the contract job; synthesizing, based on the sentiment of the user feedback and additional sentiments associated with the contract job, a summarized sentiment, wherein the summarized sentiment indicates an overall level of satisfaction associated with a performance of the contract job; and generating a task based on the user feedback and the summarized sentiment.

In some aspects, the techniques described herein relate to a method, wherein the task is one of a notification, a message, an alert, an update, an inquiry, or an automated process related to the contract job.

In some aspects, the techniques described herein relate to a method, wherein the summarized sentiment is synthesized in response to the user feedback being provided as the input to the large language model.

In some aspects, the techniques described herein relate to a method, wherein the sentiment is one of very positive, positive, neutral, negative, or angry.

In some aspects, the techniques described herein relate to a method, wherein the user feedback includes a plurality of text-based comments relating to the contract job.

In some aspects, the techniques described herein relate to a method, wherein the summarized sentiment indicates a trend or average performance of the contract job over a duration.

In some aspects, the techniques described herein relate to a method, wherein the subset of content includes personal information, a job status, content related to a contractor, or a plan for future action.

In some aspects, the techniques described herein relate to a one or more non-transitory, computer-readable media storing computer-executable instructions that, when executed by a processor of a computing device, cause the computing device to at least: receive user feedback corresponding to a contract job, wherein the user feedback includes a text-based comment; filter the text-based comment to remove a subset of content from the text-based comment; provide the user feedback as input into a large language model to output a sentiment associated with the user feedback and a sentiment score, wherein the sentiment indicates a level of satisfaction with the contract job; synthesize, based on the sentiment of the user feedback and additional sentiments associated with the contract job, a summarized sentiment, wherein the summarized sentiment indicates an overall level of satisfaction associated with a performance of the contract job; and generate a task based on the user feedback and the summarized sentiment.

In some aspects, the techniques described herein relate to a one or more non-transitory, computer-readable media, wherein the task is one of a notification, a message, an alert, an update, an inquiry, or an automated process related to the contract job.

In some aspects, the techniques described herein relate to a one or more non-transitory, computer-readable media, wherein the summarized sentiment is synthesized in response to the user feedback being provided as the input to the large language model.

In some aspects, the techniques described herein relate to a one or more non-transitory, computer-readable media, wherein the sentiment is one of very positive, positive, neutral, negative, or angry.

In some aspects, the techniques described herein relate to a one or more non-transitory, computer-readable media, wherein the summarized sentiment indicates a trend or average performance of the contract job over a duration.

In some aspects, the techniques described herein relate to a one or more non-transitory, computer-readable media, wherein the subset of content includes personal information, a job status, content related to a contractor, or a plan for future action.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a schematic block diagram of an example network environment in which a feedback analysis system may operate, according to various aspects of the present disclosure.

FIG. 2 is an example data flow process in which the feedback analysis system may operate to identify a sentiment associated with user feedback and generates a task based on the identified sentiment, according to various aspects of the present disclosure.

FIG. 3 is an example interface in which the feedback analysis system displays the identified sentiments associated with notes relating to a contract job, according to various aspects of the present disclosure.

FIG. 4 is a block diagram illustrating components of an example computing system that can be used to implement the various systems and methods described herein.

FIG. 5 is a flow diagram showing an example routine for identifying a sentiment associated with user feedback and generating a task based on the identified sentiment, according to various aspects of the present disclosure.

### DETAILED DESCRIPTION

Generally described, aspects of the present disclosure relate to efficient mechanisms for identifying a sentiment associated with user feedback (e.g., notes) relating to a contract job.

As noted herein, restoration contract jobs (“contract jobs”) may involve any type of repair, renovation, or construction work relating to a property that may be undertaken by a contractor. Contract jobs may relate to any property-based issue, such as fixing a burst pipe, rewiring electrical panels, general renovations (e.g., kitchen, bathroom), and the like. Because these jobs may often relate to emergency conditions, property owners may often contact insurance providers or other third-party systems to refer a contractor to address the issue. Direct contact between owners and contractors may be limited, and as such, feedback on the contract job may not be readily accessible. To provide feedback, property owners may submit notes through the insurance provider or other third-party system that was utilized to assign the contractor to the contract job. However, it is not guaranteed that the insurance provider will pass along notes to the contractor. As such, property owners may not be aware of whether their feedback will reach the contractors. On the other hand, contractors may not be aware that property owners have feedback relating to the contract job.

In some cases, a contract job may include various steps or smaller projects undertaken by various contractors (e.g., subcontractors) over a length of time. Feedback from property owners may vary depending on the specific task completed by the contractor throughout the duration of the contract job. Because certain contract jobs may generate a plurality of notes from a variety of authors (e.g., owners, designers, customers), contractors may not be aware of the general sentiment of the ongoing contract job. In some embodiments, users may need to access a variety of platforms to check a status of the contract job, draft and edit notes to various parties, check messages, and the like. On the other end, contractors and other third parties may need to access a variety of platforms to check notes, update status, etc. There is a need to consolidate and organize notes stemming from a contract job such that contractors and other parties can efficiently access user feedback.

As will be appreciated by one of skill in the art in light of the present disclosure, the embodiments disclosed herein improve the ability of computing systems, such as the feedback analysis system, to identify a sentiment associated with a note (or a plurality of notes) connected to a contract job. The feedback analysis system as described herein may relate to a system wherein users, such as property owners, can provide user feedback (e.g., notes) related to contract jobs performed on properties. User feedback may relate to the performance, outcome, manner, skill, etc. of a contract job, and may include a text-based comment. To determine a sentiment associated with the user feedback, the feedback analysis system can access a model, such as a large language model, to identify a sentiment (e.g., very positive, positive, neutral, negative, angry). In addition, in the case when there are multiple notes associated with a contract job, the feedback analysis system can synthesize a general sentiment relating to the contract job. For example, in some cases, a sentiment analysis system of the feedback analysis system can identify a trend or average performance of the contractors to the contract job based on the analyzed notes. Tasks based on the user feedback and summarized sentiment can be generated. Tasks generated by the task generation system of the feedback analysis system may relate to any process, such as a notification, alert, reminder, contract job-related item, and the like. Tasks generated by the task generation system can further include specific training modules or items to be completed by contractors, employees, or other parties. In some embodiments, assuming that a user is able to convey feedback of an ongoing contract job in a note, interpretation of the note may be subjective. In the case when there are differences in the primary speaking language between the user and the contractor, feedback may be misinterpreted by the contractor, leading to additional problems and miscommunications. The system as described herein may remedy this situation by providing an objective determination of sentiment, a translation of the note, or in some cases, an explanation behind the sentiment. In addition, the system as described herein may consolidate and provide a streamlined interface for all parties to check the status and sentiments of ongoing or completed jobs. This may reduce the time between complaints/notes issued by users and remedial action taken by contractors and other clients.

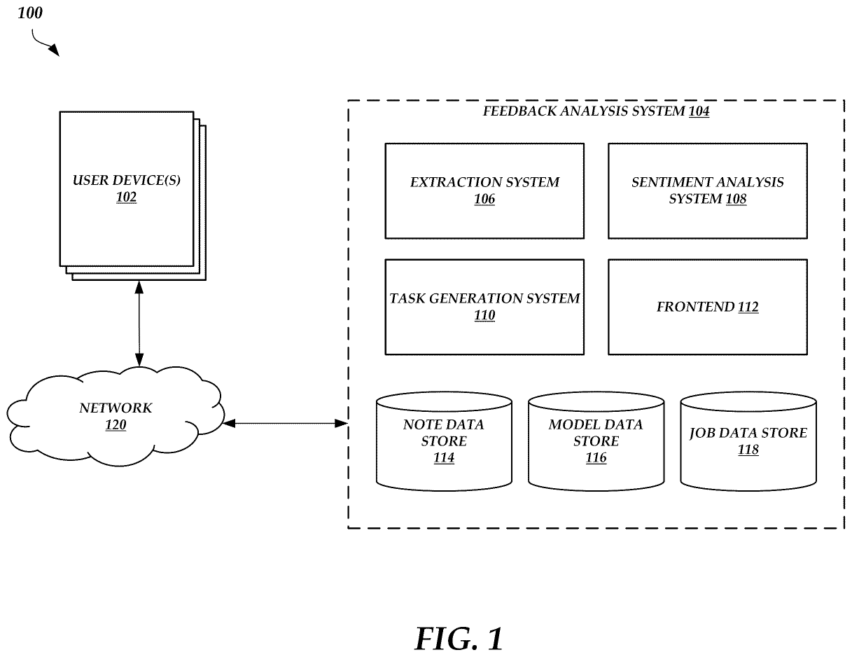

FIG. 1 is a schematic block diagram of an example network environment 100 in which a feedback analysis system 104 may operate, according to various aspects of the present disclosure. The feedback analysis system 104 may be configured to identify a sentiment associated with user feedback relating to a contract job.

As shown in FIG. 1, the network environment 100 includes user device(s) 102 (hereinafter referred to as “user device 102” for ease of reference), feedback analysis system 104, and network 120. Feedback analysis system 104 includes extraction system 106, sentiment analysis system 108, task generation system 110, frontend 112, note data store 114, model data store 116, and job data store 118. The components of the feedback analysis system 104 within network environment 100 may be communicatively coupled via network 120. In addition, network 120 may connect the user device 102 to the feedback analysis system 104 and various components of the feedback analysis system 104. The network environment 100 and components of network environment 100 can include various hardware components and software components and can provide functionality as described further herein. In addition, components of the network environment 100 and the feedback analysis system 104 can include more or less components.

In various aspects, communication among the various components of the example network environment 100 and the feedback analysis system 104 may be accomplished via any suitable device, systems, methods, and/or the like. For example, the feedback analysis system 104 may communicate with the user device 102 and any other systems (not shown), via any combination of the network 120 or any other wired or wireless communication networks, methods (e.g., Bluetooth, WiFi, infrared, cellular, and/or the like). As further described below, the network 120 may comprise, for example, one or more internal or external networks, the Internet, and/or the like.

Network 120 of the network environment 100 can include any appropriate network, including wired network, wireless network, or combination thereof. For example, network 120 may be a personal area network, local area network, wide area network, cable network, satellite network, cellular network, or any other such network or combination thereof. As a further example, the network 120 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 120 may be a private or semi-private network, such as a corporate or university intranet. The network 120 may include one or more wireless networks, such as a Global System for Mobile Communications (GSM) network, a Code Division Multiple Access (CDMA) network, a Long-Term Evolution (LTE) network, C-band, mmWave, sub-6 GHZ, or any other type of wireless network. The network 120 can use protocols and components for communicating via the Internet or any of the other aforementioned types of networks. For example, the protocols used by the network 120 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 120 can represent a network that may be local to a particular organization, e.g., a private or semi-private network, such as a corporate or university intranet. In some implementations, devices may communicate via the network 120 without traversing an external network, such as the Internet. In some implementations, devices connected via the network 120 may be walled off from accessing the Internet. As an example, the network 120 may not be connected to the Internet. Accordingly, e.g., the user device 102 may communicate with the feedback analysis system 104 directly (via wired or wireless communications) or via the network 120, without using the Internet. Thus, even if the network 120 or the Internet is down, the feedback analysis system 104 may continue to communicate and function via direct communications (and/or via the network 120).

User device 102 may be used to access various components of the network environment 100 and the feedback analysis system 104 over the network 120. User device 102 illustratively correspond to any computing device that provides a means for a user or admin to interact with components of the feedback analysis system 104. For example, a property owner, with user device 102, may access the feedback analysis system 104 via the frontend 112 to input feedback relating to a contract job. In some examples, the frontend 112 may be implemented on user device 102. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, and the like. In some implementations, user device 102 can access a cloud provider network via the network 120 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

Feedback analysis system 104 may be configured to identify a sentiment associated with user feedback relating to a contract job. In some embodiments, feedback analysis system 104 may synthesize a sentiment (or plurality of sentiments) relating to a plurality of user feedback items (e.g., notes) and update additional processes for transmitting the sentiment to third parties (e.g., contractors). Feedback analysis system 104 may have access to various databases, models, and other applications that allow the feedback analysis system 104 to generate sentiments associated with notes. As shown in FIG. 1, the feedback analysis system 104 includes various systems, such as the extraction system 106, the sentiment analysis system 108, the task generation system 110, and the frontend 112. In addition, the feedback analysis system 104 has access to various databases or data stores, such as the note data store 114, the model data store 116, and the job data store 118. Feedback analysis system 104 may include or have access to additional components not shown in FIG. 1, or may have less components than as shown. Each component of the feedback analysis system 104 will be discussed in turn below.

To facilitate interaction between the feedback analysis system 104 and a user of the user device 102 via the network 120, the feedback analysis system 104 includes the frontend 112. Frontend 112 may include any presentation layer (e.g., experience layer, user interface, etc.) such as a user-facing interface or platform through which a user of the user device 102 may access and interact with the feedback analysis system 104. In some embodiments, a user of the user device 102 submits user feedback relating to a contract job through the frontend 112.

To analyze notes from a user (e.g., property owner or manager), the feedback analysis system 104 may access various systems or components. Feedback analysis system 104 may comprise various systems or modules configured to execute processes directed to identifying a sentiment relating to a note. In a first part, the feedback analysis system 104 may access a note from the note data store 114.

Note data store 114 may be configured to store information relating to feedback of a contract job. In some embodiments, the information stored in the note data store 114 includes notes, reviews, comments, posts, messages, ratings, etc. that may be related to the performance, outcome, manner, skill, quality, etc. of work performed for or during a contract job. For example, user feedback may include a note left by a property owner after a contract job relating to the performance of the contractors: “Contractor X did a wonderful job installing the new lights in the kitchen!” In some embodiments, user feedback may be utilized by feedback analysis system 104 to determine a general sentiment or feeling of a contract job(s). In some cases, user feedback received by the feedback analysis system 104 may marginally relate to a contract job, or may be irrelevant to a contract job. This user feedback may be marked by the feedback analysis system 104 as neutral, or may be ignored by the models. More than one note may relate to a specific contract job, or a series of jobs related to a property or specific renovation project, etc. Notes relating to a contract job(s) may be written by a single or multiple authors. For example, notes relating to a specific contract job may be labeled or identified with that contract job. In some embodiments, the note data store 114 organizes or groups notes associated with a contract job or a renovation project.

Extraction system 106 may be configured to process user feedback stored in the note data store 114. To generate a sentiment based on a note, the extraction system 106 may first prepare the note(s) for input into models. In some examples, the extraction system 106 filters notes that contain personal information. For example, the extraction system 106 filters notes or comments that contain names, phone numbers, addresses, or other sensitive information. The extraction system 106 may discard the note entirely, or may block out (e.g., mask, delete, etc.) certain personal information. In some embodiments, the extraction system 106 will not pass user information with personal information to other components of the feedback analysis system 104. Alternatively, or in addition, the extraction system 106 may extract notes that relate to contract jobs for further processing by components of the feedback analysis system 104.

Sentiment analysis system 108 may be configured to identify or determine a sentiment associated with a note. A sentiment as utilized herein may refer to an attitude, opinion, feeling, etc. that is expressed by a user (e.g., author) of the user feedback. In some examples, the sentiment of a note may be qualitative, such as an indication of whether the mood of the note is very positive, positive, neutral, negative, very negative, angry, confused, frustrated, happy, sad, pleased, etc. Sentiments may also include a percentage, number, rating, etc. which may indicate a satisfaction level of the author of the note (e.g., a “neutral” note may be rated as a 50% satisfaction). To determine the sentiment of a note (or multiple notes), the sentiment analysis system 108 may access or receive notes processed by the extraction system 106. The sentiment analysis system 108 may access a model, such as a model (e.g., large language model) stored in the model data store 116 to input the note for determination of the sentiment. In some embodiments, the sentiment analysis system 108 determines multiple sentiments associated with a note.

Model data store 116 may be configured to store models, algorithms, or other processes to be accessed by the feedback analysis system 104. Models stored in the model data store 116 may include any engine, service, application, program, process, etc. configured to determine or identify a sentiment associated with user feedback. In some embodiments, the models stored in the model data store 116 may include artificial intelligence (AI) models such as machine learning (ML) models, deep learning (DL) models, large language models (LLMs), and the like. Models stored in the 116 and accessed by the feedback analysis system 104 may be configured to determine a sentiment of user feedback, e.g., based on a single note or a plurality of notes relating to contract job(s). As noted herein, the sentiment of the note may include an attitude, opinion, feeling, etc. that is expressed by a user (e.g., author) of the note. In some examples, the sentiment of a note may be qualitative, such as an indication of whether the mood of the note is very positive, positive, neutral, negative, very negative, angry, confused, frustrated, happy, sad, pleased, etc. Sentiments may also include a percentage, number, rating, etc. which may indicate a satisfaction level of the author of the note (e.g., a “positive” note may be rated as an 80%-100% satisfaction, a 4 out of 5, a 5 out of 5, etc.). In some embodiments, the LLM determines multiple sentiments associated with a note (e.g., a sentiment of a single note may include confused and angry).

Job data store 118 may be configured to store notes that have been processed by the sentiment analysis system 108 and are associated with an identified sentiment. As noted herein, notes may be associated with a specific contract job, or a series of contract jobs relating to the same property/renovation project, collectively referred to as a “contract job.” As such, notes associated with a particular contract job may be organized or grouped together within the job data store 118 along with their corresponding determined sentiments. In addition to storing the text of a note, the job data store 118 may store corresponding information associated with the note, such as the determined sentiment, time and date, author, contractor (or party rendering services related to the contract job), the contract job, etc.

Task generation system 110 may be configured to generate a task based on the identified sentiment. Tasks generated by the task generation system 110 may relate to any process related to the feedback analysis system 104, such as a notification, alert, reminder, contract job-related item, and the like. In some examples, the task generation system 110 may generate a notification to be sent out to a third party. For example, if the identified sentiment of a note is “angry,” then the task generation system 110 may generate an alert to be sent to the corresponding contractor associated with the note. In some embodiments, tasks generated by the task generation system 110 can further include specific training modules or items to be completed by contractors, employees, or other parties. Based on the determined sentiment and/or content of a note, the task generation system 110 can identify specific employees or contractors that need to perform specific training. In some embodiments, the task generation system 110 can generate a recommended training or task for employees based on the determined sentiment and note.

In some embodiments, administrator systems and other processes can review the sentiments generated by the feedback analysis system 104. Administrator system can verify generated sentiments or perform additional checks on the sentiments. For example, the administrator system can analyze historical trends or patterns in generated sentiments and flag notes/sentiments that appear to be anomalies.

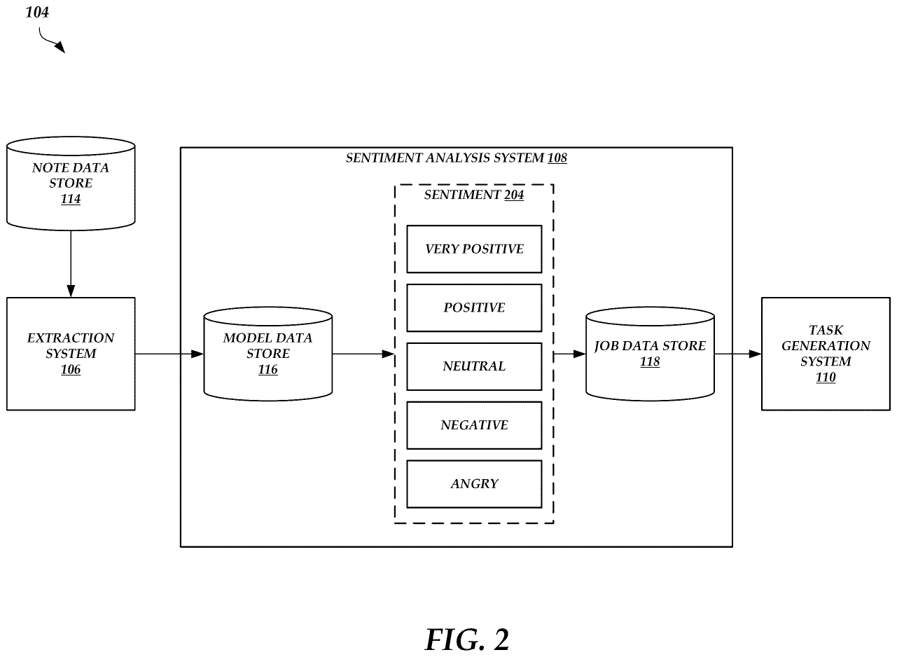

FIG. 2 is an example data flow process in which the feedback analysis system 104 may operate to identify a sentiment associated with user feedback (e.g., notes) and generates a task based on the identified sentiment.

As shown in FIG. 2, the feedback analysis system 104 accesses notes from the note data store 114. As noted herein, the notes stored in the note data store 114 can include any reviews, comments, posts, messages, notes, ratings, etc. that may be related to a contract job. In addition, the user feedback may relate to a performance, outcome, manner, skill, quality, etc. of the contract job. For example, the note may indicate a review of a contractor's performance in completing a portion of a contract job, such as: “Contractor Y completed the rewiring of the kitchen in a timely fashion, looking forward to the rest of the kitchen renovation.” In some embodiments, the feedback analysis system 104 accesses more than one note from the note data store 114. Notes accessed by the feedback analysis system 104 may relate to the same contract job. For example, a first note accessed by the feedback analysis system 104 may relate to a user's review of a first portion of a contract job completed, and a second note may relate to a second portion that of the contract job (e.g., completed at a later time).

Once accessed by the feedback analysis system 104, the extraction system 106 extracts notes that relate to contract jobs for further processing by components of the feedback analysis system 104. Additionally, or alternatively, the extraction system 106 filters the content of notes to remove personal information such as names, phone numbers, addresses, or other sensitive information. Filtering the notes may also include excluding certain notes that contain personal information from further processing by the feedback analysis system 104. As such, in some embodiments, the extraction system 106 may discard the note entirely, or may block out certain personal information from the note. Notes without personal information may be passed on to additional components of the feedback analysis system 104 from the extraction system 106. For example, after processing/extraction, the extraction system 106 may transmit the notes to the sentiment analysis system 108. In some embodiments, the extraction system 106 filters content of the notes that is not relevant to the sentiment of the note. For example, the extraction system 106 may filter or remove language relating to “actionable notes,” such as updates on job status, plans for future actions, language that reflects a contractor's position, etc. In some embodiments, any language or portions of a note that do not reflect a customer sentiment may be filtered out. By doing so, the extraction system 106 may preserve or maintain the “customer's voice” of the note.

Upon receipt of a note (or notes), the sentiment analysis system 108 provides the note into a model, such as an LLM (stored in the model data store 116). To determine a sentiment, the sentiment analysis system 108 may input the note and any corresponding prompt or instruction into the LLM to determine a sentiment 204 associated with the note. As shown in FIG. 2, sentiment 204 may include the following sentiments: Very Positive, Positive, Neutral, Negative, Angry. There may be more or less sentiments 204 than as shown. In response to the input note, the LLM may identify a sentiment 204 associated with the note. In the example above, the sentiment analysis system 108 may receive a note (“Contractor Y completed the rewiring of the kitchen in a timely fashion, looking forward to the rest of the kitchen renovation.”) from the extraction system 106 (originally accessed from the note data store 114). In this example, the sentiment analysis system 108 may input this note into an LLM configured to determine a general sentiment of this note. For example, the sentiment analysis system 108 may determine that the general sentiment 204 of the note is positive, as it appears that the author of the note is satisfied with the rewriting, but not overly ecstatic or enthusiastic about the results. In some embodiments, the sentiment analysis system 108 generates a score associated with the sentiment 204 for each note. In some embodiments, the score includes a percentage, number, rating, etc. associated with a sentiment. For example, a score of 100 may indicate the most positive sentiment (e.g., very positive), while a score of 0 may indicate the most negative sentiment (e.g., angry, very negative). Other scales, metrics, or numbers may be utilized. In some embodiments, the sentiment analysis system 108 generates a score for each note received from the extraction system 106.

In some embodiments, the sentiment analysis system 108 may determine a sentiment associated with multiple notes. As noted herein, there may be multiple notes associated with a single contract job, such may be the case when the contract job involves multiple steps or processes performed over a period of time (e.g., renovation of the entire kitchen). In this case, the sentiment analysis system 108 may determine a general sentiment associated with multiple notes that indicates an average emotion or sentiment towards the work performed. In some cases, the sentiment analysis system 108 may determine an average sentiment with the addition of new notes related to the contract job. The sentiment analysis system 108 may synthesize or summarize a general sentiment relating to a contract job. For example, the sentiment analysis system 108 may determine an average sentiment based on the existing notes related to the contract job. In some cases, the sentiment analysis system 108 may identify a trend or average performance of the contractors to the contract job based on the analyzed notes. In some embodiments, a generated summary or consolidated report of the notes may be generated by the sentiment analysis system 108 and transmitted to a computing device for display in a user interface or to a third party or device. For example, the user interface can depict a graph that shows the trend or average performance of the contractor over time.

In some embodiments, the sentiment analysis system 108 generates a contextual composite of sentiments based on multiple notes. The contextual composite may refer to a collective, summarized, or combined sentiment or score that reflects the determined sentiments for notes received up to a certain time, or certain subject matter, or any other grouping or identification. For example, the sentiment analysis system 108 may provide the note into the model for generating a sentiment and/or score of the note. In addition to generating a sentiment and score for the individual note, the model may generate a composite score based on some or all of the available notes (e.g., past notes). In some embodiments, the composite score (or contextual composite score) may indicate combined sentiment of the notes, which can include any average, weighted average, etc.

The sentiment analysis system 108, upon identification or determination of the sentiment 204, stores the note with the identified sentiment 204 in the job data store 118. Optionally, the sentiment analysis system 108 may translate the note from a first language to a second language if the note is originally written in the first language and the primary language of a contractor is the second language. The sentiment analysis system 108 may perform the note translation subsequent to the sentiment 204 being identified to produce more accurate sentiment 204 identifications given that the same words may convey different sentiments in different languages and therefore the actual sentiment of the note may be misinterpreted or lost if the sentiment 204 is identified based on a translation of the original text of the note. Alternatively, the sentiment analysis system 108 may perform the note translation prior to the sentiment 204 being identified (e.g., the sentiment 204 may be identified based on the translated note). As noted herein, job data store 118 may be configured to store notes that have been processed by the sentiment analysis system 108 and are associated with an identified sentiment. Notes associated with a particular contract job may be organized or grouped together within the job data store 118 along with their corresponding determined sentiments. In addition to storing the text of a note, the job data store 118 may store corresponding information associated with the note, such as the determined sentiment, time and date, author, contractor (or party rendering services related to the contract job), the contract job, etc.

Task generation system 110 may determine a task associated with the identified sentiments of the notes in the job data store 118. Tasks generated by the task generation system 110 may relate to any process related to the feedback analysis system 104, such as a notification, alert, reminder, contract job-related item, and the like. In some examples, the task generation system 110 may generate a notification to be sent out to a third party. Alternatively, or in addition, the task generation system 110 may generate a task relating to the workflow of the contract job. For example, if the sentiment analysis system 108 identifies that the sentiment associated with a note is “negative,” the task generation system 110 may generate an inquiry or investigation task relating to the contract job. In one example, the task generation system 110 can generate a message to a vehicle operated by a contractor to dispatch the contractor to the job site. The message generated by the task generation system 110 can even automatically update or program the vehicle's GPS system to route the vehicle to the job site. In the case when the identified sentiment is positive, the task generation system 110 may generate a text message to the user including a link to a ratings page for the contractor for the user to write and post a review. In another example, the task generation system 110 may schedule automatic messages to be sent to the user requesting follow up feedback.

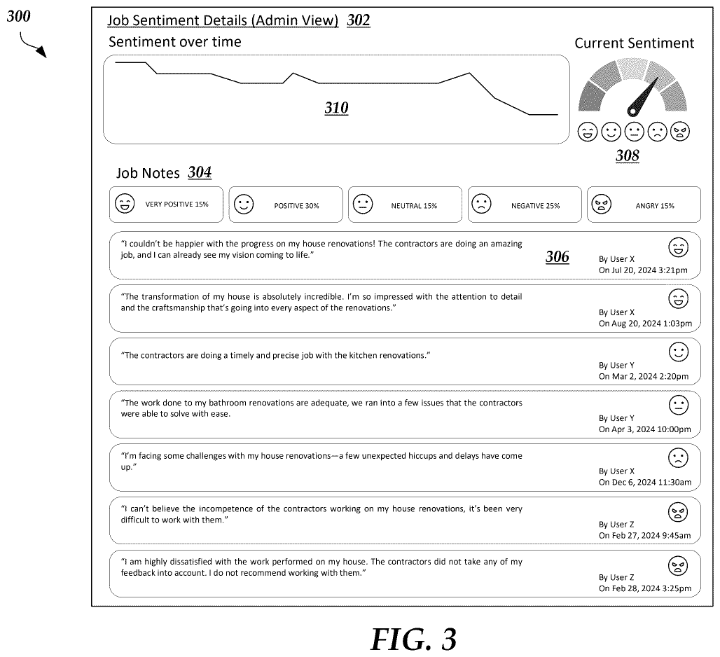

FIG. 3 is an example interface 300 in which the feedback analysis system 104 displays the identified sentiments associated with notes relating to a contract job, according to various aspects of the present disclosure. The interface 300 may be displayed on a user device 102.

As shown in FIG. 3, interface 300 comprises various areas and components relating to the notes and associated sentiments of a contract job (“job”) 302. Job 302 may involve any type of repair, renovation, or construction work relating to a property that may be undertaken by a contractor or contracting party. Job 302 may relate to any property-based issue, such as fixing a burst pipe, rewiring electrical panels, general renovations (e.g., kitchen, bathroom), and the like. In some cases, job 302 may include various steps or smaller projects undertaken by various contractors over a length of time.

Job notes area 304 may be an area of the interface 300 relating to the notes of the job 302. As shown in FIG. 2, job notes area 304 includes a summary of the various sentiments: very positive, positive, neutral, negative, angry. In addition, a percentage of the notes with the associated sentiment is shown in the summary. Job notes area 304 also includes an area for display of the notes 306. As shown, each note 306 includes the text of the original note (shown in quotations), an optional translation of the original note if the original note is written in a different language than a primary language of the contractor, and additional information. For example, the author of the note is shown along with the date and time of the note when it was written. Icons, colors, or other indicators can be included with the note 306 to indicate the identified sentiment. In some embodiments, some or all the notes related to the job 302 are shown in the job notes area 304. For example, a representative sample of all the notes related to the job 302 may be shown. In this case, a certain number of notes identified by each sentiment can be shown (two notes identified as positive, two notes identified as neutral, and so on). In some examples, only the most recent notes are shown (e.g., top 5 most recent notes), or in other cases, the oldest notes. Notes may be representative of the percentages of the sentiments (e.g., if 80% of the notes are positive, 4 out of 5 notes shown may be “positive” notes). The number and configuration of notes may include any relevant or additional configuration in the job notes areas 304.

Current sentiment 308 is also shown within the interface 300. The current sentiment 204 may indicate an average sentiment of the notes associated with job 302. Icons, pictures, symbols, illustrations, or other interface elements may be included within the interface 300 to illustrate the current sentiment 308. In addition to the current sentiment 308, the interface 300 may include an area to illustrate the sentiment over time. As shown by sentiment trend line 310, the sentiment analysis system 108 may determine a sentiment over a period of time based on the notes related to the contract job. Although not shown in FIG. 3, the Y-axis of the sentiment trend line 310 may include a level of satisfaction (e.g., percentage) or other metric indicative of the sentiment; the X-axis of the sentiment trend line 310 may be time or length of the contract job.

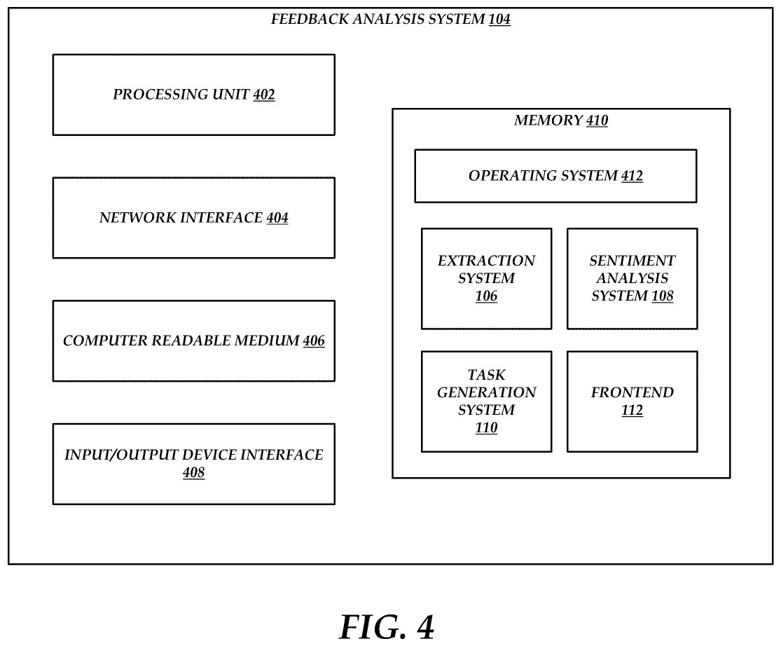

FIG. 4 is a block diagram illustrating components of an example computing system that can be used to implement the various systems and methods described herein.

The general architecture of the system depicted in FIG. 4 includes an arrangement of computer hardware and software that may be used to implement aspects of the present disclosure. The hardware may be implemented on physical electronic devices, as discussed in greater detail below. The system may include many more (or fewer) elements than those shown in FIG. 4. It is not necessary, however, that all of these generally conventional elements be shown in order to provide an enabling disclosure. Additionally, the general architecture illustrated in FIG. 4 may be used to implement one or more of the other components illustrated in the figures. As illustrated, the system includes a processing unit 402, a network interface 404, a computer-readable medium drive 406, and an input/output device interface 408, and memory 410, all of which may communicate with one another by way of a communication bus.

The network interface 404 may provide connectivity to one or more networks or computing systems. The processing unit 402 may thus receive information and instructions from other computing systems or services via the network. The processing unit 402 may also communicate to and from memory 410 and further provide output information for an optional display (not shown) via the input/output device interface 408. The input/output device interface 408 may also accept input from an optional input device (not shown).

The memory 410 may contain computer program instructions (grouped as units in some embodiments) that the processing unit 402 executes in order to implement one or more aspects of the present disclosure, along with data used to facilitate or support such execution. While shown in FIG. 4 as a single set of memory 410, memory 410 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

The memory 410 may store an operating system 412 that provides computer program instructions for use by the processing unit 402 in the general administration and operation of the feedback analysis system 104. The memory 410 may further include computer program instructions and other information for implementing aspects of the present disclosure. For example, in one embodiment, the memory 410 includes the extraction system 106, the sentiment analysis system 108, the task generation system 110, and the frontend 112. Each of these components may represent code executable to perform the processes described herein.

The system of FIG. 4 is one illustrative configuration of such a device, of which others are possible. For example, while shown as a single device, a system may in some embodiments be implemented as a logical device hosted by multiple physical host devices. In other embodiments, the system may be implemented as one or more virtual devices executing on a physical computing device. While described in FIG. 4 as a feedback analysis system 104 similar components may be utilized in some embodiments to implement other devices shown herein.

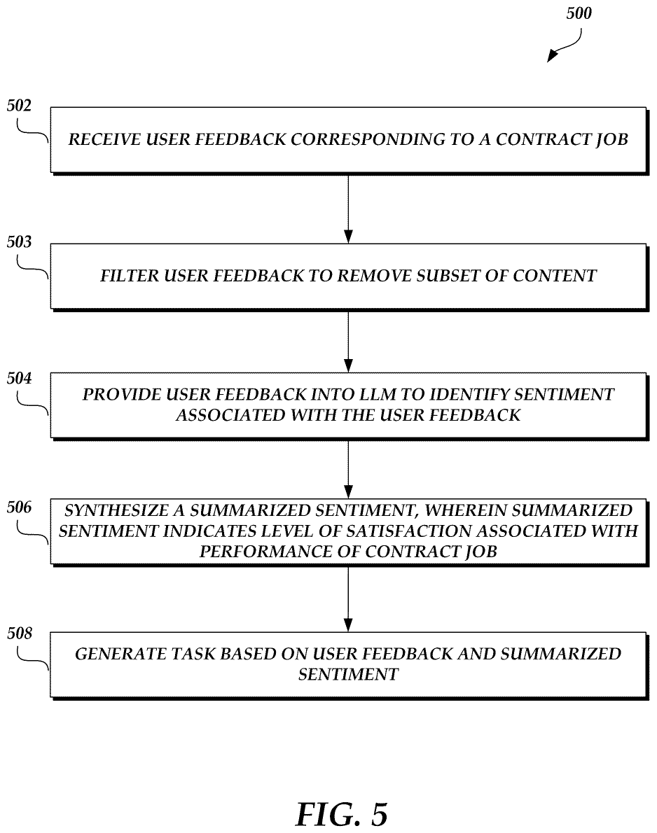

FIG. 5 is flow diagram showing an example routine for identifying a sentiment associated with user feedback and generating a task based on the identified sentiment, according to various aspects of the present disclosure. Routine 500 may be executed by the feedback analysis system 104 and various components of the feedback analysis system 104. Specifically, the routine 500 may be executed by a processor, such as the processing unit 402, shown in FIG. 4.

At block 502, user feedback relating to a contract job is received. As noted herein, the contract job may involve any type of repair, renovation, or construction work relating to a property that may be undertaken by a contractor or contracting party. The contract job may relate to any property-based issue, such as fixing a burst pipe, rewiring electrical panels, general renovations (e.g., kitchen, bathroom), and the like. In some cases, the contract job may include various steps or smaller projects undertaken by various contractors over a length of time. User feedback can include any reviews, comments, posts, messages, notes, ratings, etc. that may be related to a contract job. In addition, the user feedback may relate to a performance, outcome, manner, skill, quality, etc. of the contract job. For example, the note may indicate a review of a contractor's performance in completing a portion of a contract job, such as: “Contractor Y completed the rewiring of the kitchen in a timely fashion, looking forward to the rest of the kitchen renovation.” In some embodiments, at block 502, the feedback analysis system 104 accesses more than one note from the note data store 114. Notes accessed by the feedback analysis system 104 may relate to the same contract job. For example, a first note accessed by the feedback analysis system 104 may relate to a user's review of a first portion of a contract job completed, and a second note may relate to a second portion that of the contract job (e.g., completed at a later time).

At block 503, the user feedback is filtered to remove a subset of content, such as non-relevant information, from the user feedback. In some embodiments, the extraction system 106 filters the content of notes to remove personal information such as names, phone numbers, addresses, or other sensitive information. Filtering the notes may also include excluding certain notes that contain personal information from further processing by the feedback analysis system 104. As such, in some embodiments, the extraction system 106 may discard the note entirely, or may block out certain personal information from the note. Notes without personal information may be passed on to additional components of the feedback analysis system 104 from the extraction system 106. For example, after processing/extraction, the extraction system 106 may transmit the notes to the sentiment analysis system 108. In some embodiments, the extraction system 106 filters content of the notes that is not relevant to the sentiment of the note. For example, the extraction system 106 may filter or remove language relating to “actionable notes,” such as updates on job status, plans for future actions, language that reflects a contractor's position, etc. In some embodiments, any language or portions of a note that do not reflect a customer sentiment may be filtered out. By doing so, the extraction system 106 may preserve or maintain the “customer's voice” of the note.

At block 504, user feedback is provided into the LLM to identify the sentiment associated with the user feedback. In some embodiments, the sentiment analysis system 108 provides the feedback into a model, such as an LLM (stored in the model data store 116). To determine a sentiment, the sentiment analysis system 108 may input the note and any corresponding prompt or instruction into the LLM to determine a sentiment 204 associated with the note. As shown in FIG. 2, sentiment 204 may include the following sentiments: Very Positive, Positive, Neutral, Negative, Angry. There may be more or less sentiments. In response to the input note, the LLM may identify a sentiment 204 associated with the note. In the example above, the sentiment analysis system 108 may receive a note (“Contractor Y completed the rewiring of the kitchen in a timely fashion, looking forward to the rest of the kitchen renovation.”) from the extraction system 106 (originally accessed from the note data store 114). In this example, the sentiment analysis system 108 may input this note into an LLM configured to determine a general sentiment of this note. For example, the sentiment analysis system 108 may determine that the general sentiment 204 of the note is positive, as it appears that the author of the note is satisfied with the rewriting, but not overly ecstatic or enthusiastic about the results.

In some embodiments, at block 504, the sentiment analysis system 108 may determine a sentiment associated with multiple notes. As noted herein, there may be multiple notes associated with a single contract job, such may be the case when the contract job involves multiple steps or processes performed over a period of time (e.g., renovation of the entire kitchen). In this case, the sentiment analysis system 108 may determine a general sentiment associated with multiple notes that indicates an average emotion or sentiment towards the work performed.

In some embodiments, the sentiment analysis system 108, upon identification or determination of the sentiment 204, the sentiment analysis system 108 stores the note with the identified sentiment 204 in the job data store 118. As noted herein, job data store 118 may be configured to store notes that have been processed by the sentiment analysis system 108 and are associated with an identified sentiment. Notes associated with a particular contract job may be organized or grouped together within the job data store 118 along with their corresponding determined sentiments. In addition to storing the text of a note, the job data store 118 may store corresponding information associated with the note, such as the determined sentiment, time and date, author, contractor (or party rendering services related to the contract job), the contract job, etc.

At block 506, the summarized sentiment is synthesized. In some embodiments, the summarized sentiment indicates a level of satisfaction associated with a performance of the contract job. In some cases, the sentiment analysis system 108 may determine an average sentiment with the addition of new notes related to the contract job. The sentiment analysis system 108 may synthesize or summarize a general sentiment relating to a contract job. For example, the sentiment analysis system 108 may determine an average sentiment based on the existing notes related to the contract job. In some cases, the sentiment analysis system 108 may identify a trend or average performance of the contractors to the contract job based on the analyzed notes. In some embodiments, a generated summary or consolidated report of the notes may be generated by the sentiment analysis system 108 and transmitted to a computing device for display or to a third party or device.

At block 508, a task is generated based on the user feedback and summarized sentiment. In some embodiments, at block 508, the task generation system 110 may determine a task associated with the identified sentiments of the notes in the job data store 118. Tasks generated by the task generation system 110 may relate to any process related to the feedback analysis system 104, such as a notification, alert, reminder, contract job-related item, and the like. In some examples, the task generation system 110 may generate a notification to be sent out to a third party. Alternatively, or in addition, the task generation system 110 may generate a task relating to the workflow of the contract job. For example, if the sentiment analysis system 108 identifies that the sentiment associated with a note is “negative,” the task generation system 110 may generate an inquiry or investigation task relating to the contract job.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system, comprising:
a computer-readable storage medium storing program instructions; and
one or more processors configured to execute the program instructions to cause the system to:
receive user feedback corresponding to a contract job, wherein the user feedback includes a text-based comment;
filter the text-based comment to remove a subset of content from the text-based comment;
provide the user feedback as input into a large language model to output a sentiment associated with the user feedback and a sentiment score, wherein the sentiment indicates a level of satisfaction with the contract job;
synthesize, based on the sentiment of the user feedback and additional sentiments associated with the contract job, a summarized sentiment, wherein the summarized sentiment indicates an overall level of satisfaction associated with a performance of the contract job; and
generate a task based on the user feedback and the summarized sentiment.

2. The system of claim 1, wherein the task is one of a notification, a message, an alert, an update, an inquiry, or an automated process related to the contract job.

3. The system of claim 1, wherein the summarized sentiment is synthesized in response to the user feedback being provided as the input to the large language model.

4. The system of claim 1, wherein the sentiment is one of very positive, positive, neutral, negative, or angry.

5. The system of claim 1, wherein the user feedback includes a plurality of text-based comments relating to the contract job.

6. The system of claim 1, wherein the summarized sentiment indicates a trend or average performance of the contract job over a duration.

7. The system of claim 1, wherein the subset of content includes personal information, a job status, content related to a contractor, or a plan for future action.

8. A method, comprising:
receiving user feedback corresponding to a contract job, wherein the user feedback includes a text-based comment;
filtering the text-based comment to remove a subset of content from the text-based comment;
providing the user feedback as input into a large language model to output a sentiment associated with the user feedback and a sentiment score, wherein the sentiment indicates a level of satisfaction with the contract job;
synthesizing, based on the sentiment of the user feedback and additional sentiments associated with the contract job, a summarized sentiment, wherein the summarized sentiment indicates an overall level of satisfaction associated with a performance of the contract job; and
generating a task based on the user feedback and the summarized sentiment.

9. The method of claim 8, wherein the task is one of a notification, a message, an alert, an update, an inquiry, or an automated process related to the contract job.

10. The method of claim 8, wherein the summarized sentiment is synthesized in response to the user feedback being provided as the input to the large language model.

11. The method of claim 8, wherein the sentiment is one of very positive, positive, neutral, negative, or angry.

12. The method of claim 8, wherein the user feedback includes a plurality of text-based comments relating to the contract job.

13. The method of claim 8, wherein the summarized sentiment indicates a trend or average performance of the contract job over a duration.

14. The method of claim 8, wherein the subset of content includes personal information, a job status, content related to a contractor, or a plan for future action.

15. One or more non-transitory, computer-readable media storing computer-executable instructions that, when executed by a processor of a computing device, cause the computing device to at least:
receive user feedback corresponding to a contract job, wherein the user feedback includes a text-based comment;
filter the text-based comment to remove a subset of content from the text-based comment;
provide the user feedback as input into a large language model to output a sentiment associated with the user feedback and a sentiment score, wherein the sentiment indicates a level of satisfaction with the contract job;
synthesize, based on the sentiment of the user feedback and additional sentiments associated with the contract job, a summarized sentiment, wherein the summarized sentiment indicates an overall level of satisfaction associated with a performance of the contract job; and
generate a task based on the user feedback and the summarized sentiment.

16. The one or more non-transitory, computer-readable media of claim 15, wherein the task is one of a notification, a message, an alert, an update, an inquiry, or an automated process related to the contract job.

17. The one or more non-transitory, computer-readable media of claim 15, wherein the summarized sentiment is synthesized in response to the user feedback being provided as the input to the large language model.

18. The one or more non-transitory, computer-readable media of claim 15, wherein the sentiment is one of very positive, positive, neutral, negative, or angry.

19. The one or more non-transitory, computer-readable media of claim 15, wherein the summarized sentiment indicates a trend or average performance of the contract job over a duration.

20. The one or more non-transitory, computer-readable media of claim 15, wherein the subset of content includes personal information, a job status, content related to a contractor, or a plan for future action.
